(19) United States
(12) Patent Application Publication
(10) Pub. No.: US 2009/0316865 A1
(43) Pub. Date: Dec. 24, 2009

(54) Method for providing green service to a communication unit

(76) Inventors: David A. Jones, Orland Hills, IL (US); John C. Zglobicki, Plano, IL (US)

Correspondence Address: Lucent Technologies Inc., Docket Administrator - Room 2F-192, 600-700 Mountain Ave., Murray Hill, NJ, 07974-0636, US

(21) Appl. No.: 12/214,711

(22) Filed: Jun. 20, 2008

(51) Int. Cl. H04M 1/64; H04M 3/42

(52) U.S. Cl. 379/88.22; 379/201.02

(57) ABSTRACT

The present invention provides a method for providing green service to a mobile unit. A mobile unit subscribes to a green service, which charges the mobile unit an additional fee. The fee goes into an account that is separate from the operational account of the service provider. Funds from this account are used to pay for investing in, installing, and using alternative energy sources. Upon receiving a call for a user of the green service, the service provider plays a message to the caller. The message includes information about the green service, such as the fact that the called party has subscribed to the service and may invite the caller to also subscribe to the green service.

### FIELD OF THE INVENTION

The present invention relates generally to communication systems, and more particularly to service plan features.

### BACKGROUND OF THE INVENTION

Many scientists are concerned about the impact of greenhouse gases on the environment. One approach to addressing the possible impact of greenhouse gases on the environment is through the installation and use of alternative energy sources.

One problem with alternative energy sources is cost. If alternative energy sources were cost-effective, they would have wide acceptance and would no longer be considered “alternative”.

In a highly competitive economic environment it is difficult to pass on higher energy costs to customers.

Therefore, a need exists for a method of decreasing the use of fuels that generate greenhouse gases that is economically feasible.

### BRIEF SUMMARY OF THE INVENTION

The present invention relates generally to providing a green service in a communication system. The service provider, such as a wireless service provider or wireline service provider, typically performs customer billing. This can be done by mailing a bill for service to a subscriber, by sending an email, or by other means of alerting a subscriber that a payment is due for service provided by the service provider.

The service provider receives a customer payment, which can be paid in various ways using various methods. The service provider preferably places the customer payment in a first account, preferably an operational account. Expenses that arise from providing service to subscribers are paid from this operational account.

The service provider also determines whether the subscriber has subscribed to the green service. If the current subscriber has subscribed to the green service, the service provider preferably receives a customer payment for the green service.

The service provider preferably places the customer payment in a second account that is different than that first account, such as a green funds account. The funds in this second account are preferably used to pay for environmentally-friendly goods and services. For example, funds from the green funds account may be used to purchase power from companies that obtain their power from renewable energy sources. Alternately, funds from the green funds account may be used to purchase new equipment that is energy-efficient to replace older less energy-efficient equipment. Further, funds from the green funds account may be invested in research efforts into energy-efficient technology.

The subscriber to the green service can alternately be charged for the green service each time a caller calls them. This allows the subscriber to pay a fee for each call received, thereby offsetting a portion of his or her energy usage. In accordance with a first exemplary embodiment, a subscriber is charged a fixed amount for each call received. In accordance with a second exemplary embodiment, a subscriber is charged an amount based upon various factors, such as the length of the call, the estimated amount of energy used to complete the call, the number of cell sites involved in completing the call, time of day, or other factors.

When utilizing the green service, the network of the service provider receives a call request for a mobile unit or other subscriber. The network determines if the called subscriber has subscribed to the green service. If the subscriber has subscribed to the green service, the service provider plays a green message to the caller. In an exemplary embodiment, the green message is an announcement played to the caller while the network locates the called mobile unit or other subscriber and alerts the called unit of the incoming call request. The green message is preferably a message that alerts the caller that the called party has subscribed to the green service. The green message may include details about the green service.

In one exemplary embodiment, the caller can decide not to hear the announcement. In this exemplary embodiment, the network determines if it should play an announcement to the caller by checking information about the caller with a database of callers who have said that they do not wish to hear the green message. In this embodiment, the network asks the caller, preferably at the end of playing the green message, if the caller would like to skip the green message the next time it calls a subscriber to the network.

In a second exemplary embodiment, a caller can press a key sequence to skip the green message. For example, the caller may press “*3” or any other predetermined key sequence to skip the green message.

In accordance with an exemplary embodiment, the network may invite the caller to join the green service. The network asks the caller if the caller would like to subscribe to the green service. If the caller answers yes, such as by speaking the word “Yes” into his or her phone or by pressing a predetermined key on the keypad of the calling phone, then the wireless service provider enrolls the calling phone in the green service. While the enrollment process occurs, the call request is paused. Upon completing the enrollment process, the call request is reinitiated and the called party is contacted. In an exemplary embodiment, the wireless service provider provides a check to ensure that the calling phone is truly interested in signing up for the green service, such as by calling the calling phone at a later time or sending paperwork to the owner of the account asking for verification.

In a second exemplary embodiment, the network sends a text message to the caller reminding them of their request to sign up for the green service. This message may be sent after the network determines that the call with the called mobile unit has ended. The text message may include a link to a website that allows the caller to sign up for the green service.

In a further exemplary embodiment, the network can, upon receive an affirmative response from the caller regarding the caller's desire to sign up for the green service, immediately connect the caller to an operator or online registration process. The caller would give information and confirm that he or she was interested in signing up for the green service at that time. Upon completing this process, the caller would then be connected to the called unit. In this exemplary embodiment, the caller's call request is paused while the caller is registered for the green service and upon completion of registration the call request is continued.

The network performs call processing on the call request. For example, if the called unit responds to the call request the call is established. If the called unit does not answer the call request, the caller can be routed to the voice mail account of the called unit.

### BRIEF DESCRIPTION OF THE SEVERAL VIEWS OF THE DRAWINGS

FIG. 1 depicts a wireless communication system in accordance with an exemplary embodiment of the present invention.

FIG. 2 depicts a flowchart of a method for performing billing for a green service in accordance with an exemplary embodiment of the present invention.

FIG. 3 depicts a flowchart of a method for utilizing a green service and inviting a caller to join the green service in accordance with an exemplary embodiment of the present invention.

FIG. 4 depicts a flowchart of a method for utilizing a green service and charging the user a variable amount in accordance with an exemplary embodiment of the present invention.

FIG. 5 depicts a flowchart of a method for utilizing a green service with optional message announcement in accordance with an exemplary embodiment of the present invention.

### DETAILED DESCRIPTION OF THE INVENTION

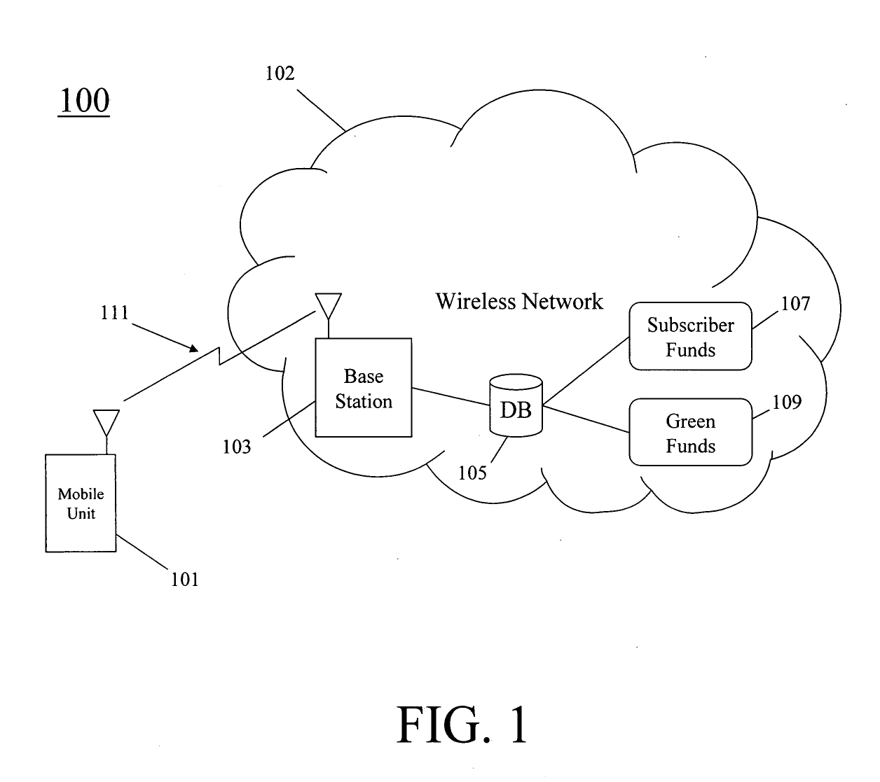

The present invention can be better understood with reference to FIGS. 1-5. FIG. 1 depicts wireless communication system 100 in accordance with an exemplary embodiment of the present invention. Wireless communication system 100 includes mobile unit 101 and wireless network 102. Wireless network 102 includes base station 103, database 105, subscriber funds account 107, and green funds account 109.

It should be understood that wireless communication system 100 typically includes a plurality of mobile units and wireless network 102 preferably includes a plurality of base stations and also additional equipment, but only mobile unit 101, base station 103, database 105, subscriber funds account 107, and green funds account 109 are depicted in FIG. 1 for the sake of clarity.

Although the embodiments depicted in FIGS. 1-5 refer to a “mobile unit”, it should be understood that the present invention is equally applicable to landline phone, VoIP phones, or any other communication unit that obtains service from a service provider.

Mobile unit 101 is preferably a wireless unit that is capable of use in wireless communication system 100. For example, mobile unit 101 can be a cellular phone, a pager, a wireless terminal, or any other wireless equipment that is capable of being used in a wireless system.

It should be understood that although a mobile unit is depicted in FIG. 1 for clarity in this exemplary embodiment, the user utilizing the green service could be using any type of communication device that requires service, such as a landline phone or a Voice over IP (VoIP) phone.

Wireless network 102 is a network that facilitates communication between mobile units and other mobile units or devices connected to networks that are connected to wireless network 102.

Base station 103 is a network element that provides over the air communication with mobile units and also communication with core network elements within wireless network 102. Wireless network 102 preferably includes a plurality of base stations.

Database 105 includes information regarding the service provided to subscribing mobile units, such as mobile unit 101. Database 105 includes calling plan information for mobile unit 101 and other mobile units.

Subscriber funds account 107 is an account that includes revenue generated from telecommunications services provided to subscribers. Subscriber funds account 107 is utilized for operational purposes. For example, subscribers paying for mobile services pay a monthly bill and the money paid is routed to subscriber funds account 107. Funds in subscriber funds account 107 are preferably used to pay operating expenses for wireless network 102.

Green funds account 109 includes funds generated from a green service. In accordance with an exemplary embodiment, a green service is an offering provided by wireless network 102 that charges a fee and wherein the fee preferably goes to an account that is used to pay for environmentally-friendly expenses. For example, the money in green funds account 109 can be used to invest in energy-saving equipment. Alternately, the money in green funds account 109 can be used on investments in alternate fuels and other environmentally friendly technologies.

In accordance with an exemplary embodiment, a wireless service provider offers a green service to its subscribers. The green service is a service that charges a fee to a subscriber and places that fee into green funds account 109. When a caller calls a subscriber to the green service, the caller hears a message informing them that the called party has subscribed to the green service. This message preferably plays while the wireless network finds and alerts the called mobile unit of the incoming call.

Signal 111 is an over the air signal that is transmitted between mobile unit 101 and base station 103.

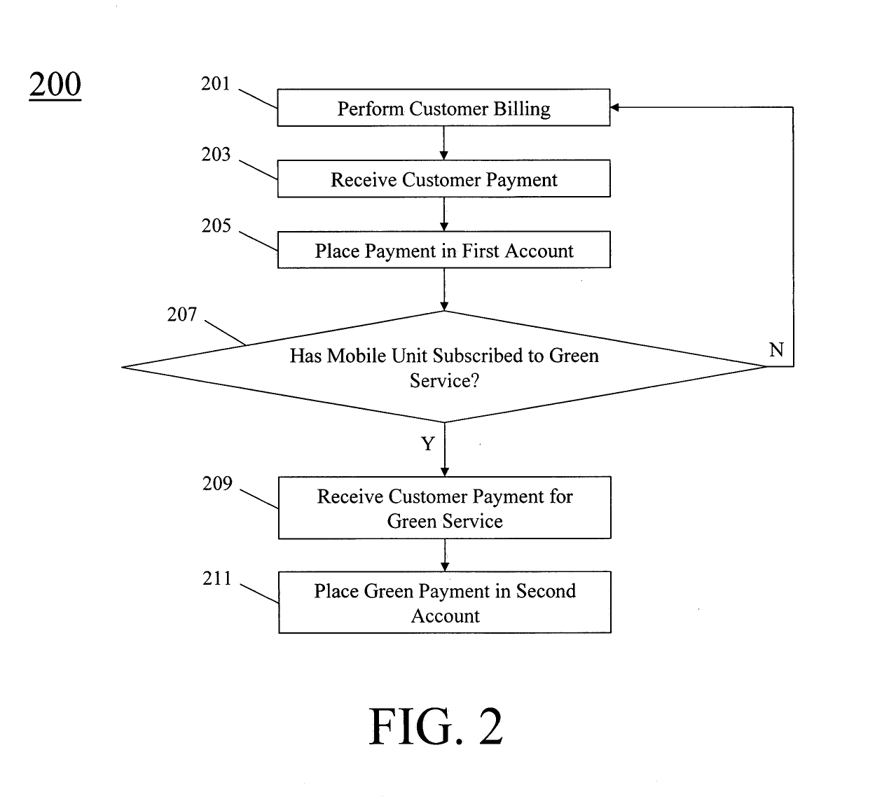

FIG. 2 depicts a flowchart 200 of a method for performing billing for a green service in accordance with an exemplary embodiment of the present invention.

Wireless network 102 performs (201) customer billing. This can be done by mailing a bill for service to a subscriber, by sending an email, or by other means of alerting a subscriber that a payment is due for service provided by wireless network 102. Customer billing refers to charging a subscriber for services that they receive from wireless network 102.

Wireless network 102 receives (203) a customer payment. The payment can be paid in various ways using various methods. For example, a subscriber can send a check in the mail, pay electronically, have an online account automatically debited, or use any other suitable means to pay for service in wireless network 102.

Wireless network 102 places (205) the customer payment in a first account. In an exemplary embodiment, wireless network 102 places the customer payments into an operational account, such as subscriber funds account 107. Expenses that arise from providing service to subscribers are paid from subscriber funds account 107.

Wireless network 102 determines (207) whether the mobile unit has subscribed to the green service. In an exemplary embodiment, this is accomplished by checking a field in a subscriber record associated with the mobile unit. If the subscriber being billed has not subscribed to the green service, the process returns to step 201 to bill the next subscriber.

If the current subscriber has subscribed to the green service as determined at step 207, wireless network 102 receives (209) a customer payment for the green service. The payment can be received in various ways, such as cash, check, credit card, debit card, electronic transfer, or any other suitable method.

Wireless network 102 places (211) the customer payment in a second account that is different than that first account, such as green funds account 109. In an exemplary embodiment, the funds in green funds account 109 are used to pay for environmentally-friendly goods and services. For example, funds from green funds account 109 may be used to purchase power from companies that obtain their power from renewable energy sources. Alternately, funds from green funds account 109 may be used to purchase new equipment that is energy-efficient to replace older less energy-efficient equipment. Further, funds from green funds account 109 may be invested in research efforts into energy-efficient technology.

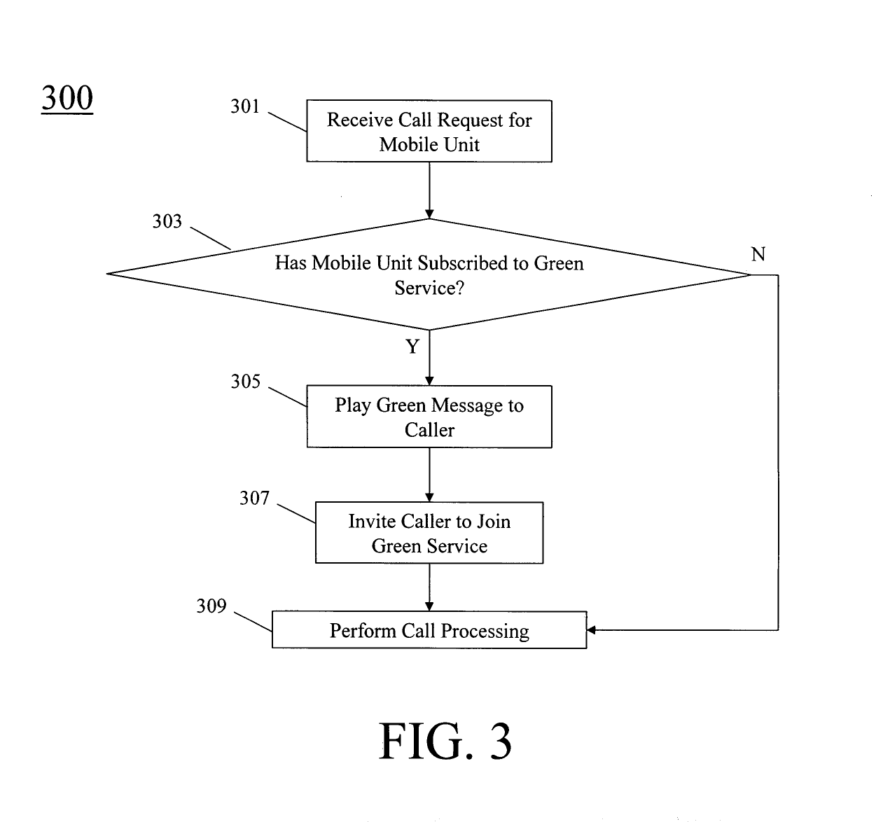

FIG. 3 depicts a flowchart 300 of a method for utilizing a green service and inviting a caller to join the green service in accordance with an exemplary embodiment of the present invention.

Wireless network 102 receives (301) a call request for mobile unit 101. The call request can come from another subscriber to wireless network 102 or from another network.

Wireless network 102 determines (303) if called mobile unit 101 has subscribed to the green service. In an exemplary embodiment, wireless network 102 accesses a subscriber record associated with a subscriber to determine if the subscriber has subscribed to the green service. If called mobile unit 101 has not subscribed to the green service, wireless network 102 performs (309) call processing for the call request.

If mobile unit 101 has subscribed to the green service, wireless network 102 performs steps 305 and 307.

Wireless network 102 plays (305) a green message to the caller. In an exemplary embodiment, the green message is an announcement played to the caller while wireless network 102 locates called mobile unit 101 and alerts called mobile unit 101 of the incoming call request. The green message is preferably a message that alerts the caller that the called party has subscribed to the green service. The green message may include details about the green service. In an exemplary embodiment, the green message gives details about the green service. In this manner, the service provider who owns wireless network 102 received money from the green service that can be used for environmentally-friendly projects, and the subscriber is recognized for his or her contribution to the environment during every call received.

In the exemplary embodiment depicted in FIG. 3, wireless network 102 invites (307) the caller to join the green service. In an exemplary embodiment, if the caller is a subscriber to wireless network 102, wireless network asks the caller if the caller would like to subscribe to the green service. If the caller answers yes, such as by speaking the word “Yes” into his or her phone or by pressing a predetermined key on the keypad of the calling phone, then the wireless service provider enrolls the calling phone in the green service. While the enrollment process occurs, the call request is paused. Upon completing the enrollment process, the call request is reinitiated and the called party is contacted. In an exemplary embodiment, the wireless service provider provides a check to ensure that the calling phone is truly interested in signing up for the green service, such as by calling the calling phone at a later time or sending paperwork to the owner of the account asking for verification.

In a second exemplary embodiment, wireless network 102 sends a text message to the caller reminding them of their request to sign up for the green service. This message may be sent after wireless network 102 determines that the call with the called mobile unit has ended. The text message may include a link to a website that allows the caller to sign up for the green service.

In a further exemplary embodiment, wireless network 102 can, upon receive an affirmative response from the caller regarding the caller's desire to sign up for the green service, immediately connect the caller to an operator or online registration process. The caller would give information and confirm that he or she was interested in signing up for the green service at that time. Upon completing this process, the caller would then be connected to the called unit. In this exemplary embodiment, the caller's call request is paused while the caller is registered for the green service and upon completion of registration the call request is continued.

Wireless network 102 performs (309) call processing on the call request. For example, if mobile unit 101 responds to the call request the call is established. If mobile unit 101 does not answer the call request, the caller can be routed to the voice mail account of mobile unit 101.

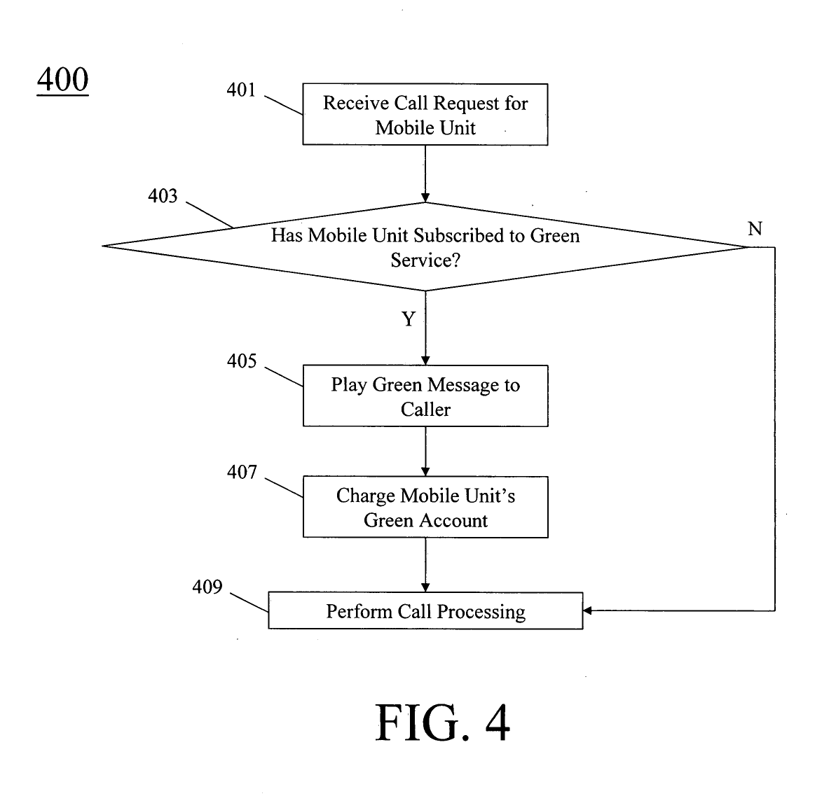

FIG. 4 depicts a flowchart 400 of a method for utilizing a green service and charging the user a variable amount in accordance with an exemplary embodiment of the present invention.

Wireless network 102 receives (401) a call request for mobile unit 101. The call request can come from another subscriber to wireless network 102 or from another network.

Wireless network 102 determines (403) if called mobile unit 101 has subscribed to the green service. In an exemplary embodiment, wireless network 102 accesses a subscriber record associated with a subscriber to determine if the subscriber has subscribed to the green service. If called mobile unit 101 has not subscribed to the green service, wireless network 102 performs (409) call processing for the call request.

Wireless network 102 plays (405) a green message to the caller. In an exemplary embodiment, the green message is an announcement played to the caller while wireless network 102 locates called mobile unit 101 and alerts called mobile unit 101 of the incoming call request. The green message is preferably a message that alerts the caller that the called party has subscribed to the green service. The green message may include details about the green service. In an exemplary embodiment, the green message gives details about the green service. In this manner, the service provider who owns wireless network 102 received money from the green service that can be used for environmentally-friendly projects, and the subscriber is recognized for his or her contribution to the environment during every call received.

In accordance with the exemplary embodiment depicted in FIG. 4, wireless network 102 charges (407) the green account of mobile unit 101. In this exemplary embodiment, subscribers to the green service are charged each time a caller calls them. This allows the user of mobile unit 101 to pay a fee for each call received, thereby offsetting a portion of his or her energy usage.

In accordance with a first exemplary embodiment, mobile unit 101 is charged a fixed amount for each call received. In accordance with a second exemplary embodiment, mobile unit 101 is charged an amount based upon various factors, such as the length of the call, the estimated amount of energy used to complete the call, the number of cell sites involved in completing the call, time of day, or other factors.

Wireless network 102 performs (409) call processing on the call request. For example, if mobile unit 101 responds to the call request the call is established. If mobile unit 101 does not answer the call request, the caller can be routed to the voice mail account of mobile unit 101.

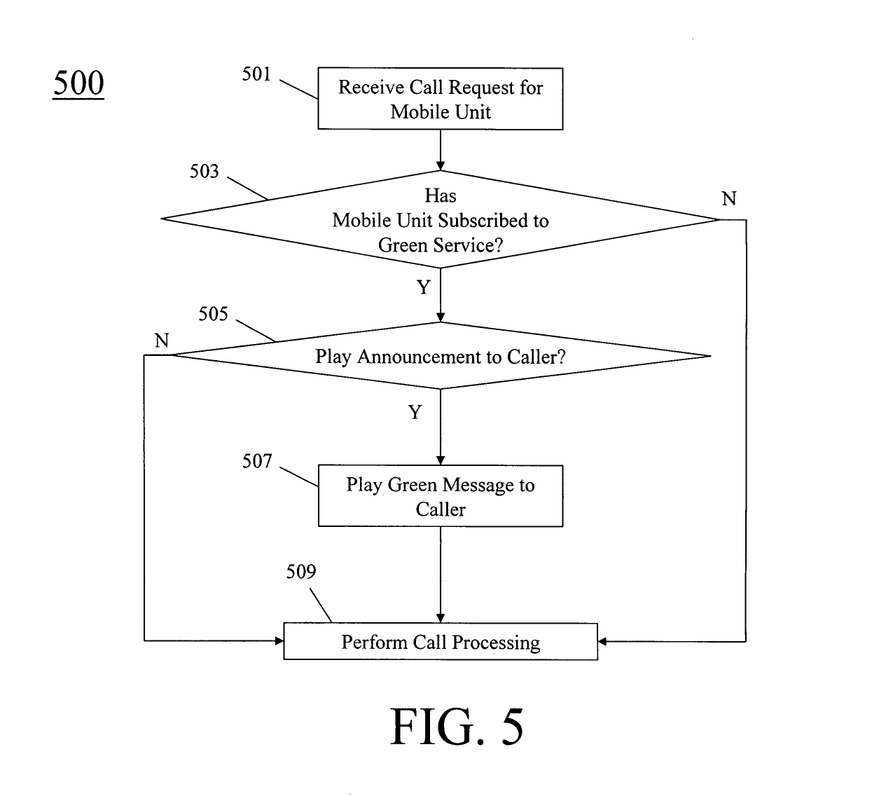

FIG. 5 depicts a flowchart 500 of a method for utilizing a green service with optional message announcement in accordance with an exemplary embodiment of the present invention.

Wireless network 102 receives (501) a call request for mobile unit 101. The call request can come from another subscriber to wireless network 102 or from another network.

Wireless network 102 determines (503) if called mobile unit 101 has subscribed to the green service. In an exemplary embodiment, wireless network 102 accesses a subscriber record associated with a subscriber to determine if the subscriber has subscribed to the green service. If called mobile unit 101 has not subscribed to the green service, wireless network 102 performs (509) call processing for the call request.

If the mobile unit has subscribed to the green service as determined at step 503, wireless network 102 determines (505) if it should play an announcement to the caller. If not, processing continues to step 509.

In an exemplary embodiment, wireless network 102 determines if it should play an announcement to the caller by checking information about the caller with a database of callers who have said that they do not wish to hear the green message. In this embodiment, wireless network 102 asks the caller, preferably at the end of playing the green message, if the caller would like to skip the green message the next time it calls a subscriber to wireless network 102.

In a second exemplary embodiment, a caller can press a key sequence to skip the green message. For example, the caller may press “*3” or any other predetermined key sequence to skip the green message.

If an announcement should be played to the caller, the wireless network plays (507) a green message to the caller alerting the caller of the subscription to the green service of mobile unit 101.

While this invention has been described in terms of certain examples thereof, it is not intended that it be limited to the above description, but rather only to the extent set forth in the claims that follow.

We claim:

1. A method comprising:
receiving a call request for a communication unit from a caller;
determining if the communication unit has subscribed to a service; and
if the communication unit has subscribed to the service, playing a message to the caller, the message including information about the service.

2. A method in accordance with claim 1, wherein the step of playing a message to the caller comprises playing a message to the caller while the communication unit is located.

3. A method in accordance with claim 1, wherein the message comprises a green message that alerts the caller that the communication unit has subscribed to a green service.

4. A method in accordance with claim 1, the method further comprising the step of inviting the caller to join the service.

5. A method in accordance with claim 4, the method further comprising the step of enrolling the caller in the service by sending a text message to the caller.

6. A method in accordance with claim 1, the method further comprising the step of charging an account of the communication unit for the service by charging the account each time the communication unit receives a call.

7. A method in accordance with claim 6, wherein the step of charging the account each time the communication unit receives a call comprises charging the account a fixed amount each time the communication unit receives a call.

8. A method in accordance with claim 6, wherein the step of charging the account each time the communication unit receives a call comprises charging the account a variable amount each time the communication unit receives a call.

9. A method in accordance with claim 8, wherein the step of charging the account a variable amount each time the communication unit receives a call comprises charging the account an amount that is based upon the length of the call.

10. A method in accordance with claim 8, wherein the step of charging the account a variable amount each time the communication unit receives a call comprises charging the account an amount that is based on the estimated amount of energy used to complete the call.

11. A method in accordance with claim 8, wherein the step of charging the account a variable amount each time the communication unit receives a call comprises charging the account an amount that is based on the number of cell sites involved in completing the call.

12. A method in accordance with claim 8, wherein the step of charging the account a variable amount each time the communication unit receives a call comprises charging the account an amount that is based on the time of day.

13. A method for performing billing for a green service comprising:
receiving a payment from a subscriber for subscriber services;
placing the payment into a first account;
if the subscriber has subscribed to a green service, receiving a payment from the subscriber for the green service;
receiving a green payment for the green service; and
placing the green payment in a second account that is different than that first account.

14. A method for performing billing for a green service in accordance with claim 13, further comprising the step of paying for operational expenses from the first account.

15. A method for performing billing for a green service in accordance with claim 13, the method further comprising the step of purchasing power from companies that obtain their power from renewable energy sources with funds from the second account.

16. A method for performing billing for a green service in accordance with claim 13, the method further comprising the step of purchasing new equipment that is energy-efficient using funds from the second account.

17. A method for performing billing for a green service in accordance with claim 13, the method further comprising the step of investing in research efforts into energy-efficient technology.

18. A method comprising:
receiving a call request for a mobile unit from a caller;
determining if the mobile unit has subscribed to a service;
if the mobile unit has subscribed to the service, determining if a message should be played to the caller, the message including information about the service; and
playing the message if it is determined that the message should be played to the caller.

19. A method in accordance with claim 18, wherein the step of determining if a message should be played to the caller comprises checking information about the caller with a database of callers who have said that they do not wish to hear the message.

20. A method in accordance with claim 18, wherein the step of determining if a message should be played to the caller comprises determining that the caller has pressed a predetermined key sequence.
